(19) United States
(12) Patent Application Publication
(10) Pub. No.: US 2004/0267731 A1
(43) Pub. Date: Dec. 30, 2004

(54) Method and system to facilitate building and using a search database

(76) Inventors: Louis Marcel Gino Monier, Menlo Park, CA (US); Eric Noel Billingsley, Campbell, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/831,422

(22) Filed: Apr. 23, 2004

Related U.S. Application Data
(60) Provisional application No. 60/465,835, filed on Apr. 25, 2003.
(60) Provisional application No. 60/465,409, filed on Apr. 25, 2003.

(51) Int. Cl. G06F 17/00

(52) U.S. Cl. 707/3

(57) ABSTRACT

A method and system to build a search database. The system analyzes a data item to be stored in the search database by using a characteristic rule. The system characterizes the data item based on the analysis. The system subsequently receives a search request against the search database and generates a search result that is filtered based on the characterization of the data item.

### CROSS-REFERENCE TO RELATED APPLICATIONS

This application claims the benefit of U.S. Provisional Application No. 60/465,835, filed Apr. 25, 2003 and U.S. Provisional Application No. 60/465,409, filed Apr. 25, 2003, which are both incorporated herein by reference.

### FIELD OF THE INVENTION

An embodiment relates generally to the technical field of search automation and specifically to a method and system for building and using a search database.

### BACKGROUND OF THE INVENTION

A search engine is a tool that identifies data items in a database and returns the identified data items in a search result. A search engine may aid the processing of data items by providing filtering mechanisms that enable the removal of unwanted data items from the search result. Removing unwanted data items increases the likelihood that the search result contains data items that are meaningful to the user. Nevertheless, filtering may introduce an unacceptable delay in responding to the user because the processing required to filter is performed after the search request is entered by the user and before the search result is returned to the user.

### SUMMARY OF THE INVENTION

A method to build a search database. The method includes analyzing a data item to be stored in the search database by using a characteristic rule to characterize the data item. The characterized data item facilitates the filtering of a subsequent search result that is generated responsive to a search request received against the search database.

### BRIEF DESCRIPTION OF THE DRAWINGS

The present invention is illustrated by way of example and not limitation in the figures of the accompanying drawings, in which like references indicate similar elements and in which:

FIG. 1 is a network diagram depicting a system, according to one exemplary embodiment of the present invention;

FIG. 2 is a block diagram illustrating multiple marketplace and payment applications that, in one exemplary embodiment of the present invention, are provided as part of the network-based trading platform;

FIG. 3 is a high-level entity-relationship diagram, illustrating various tables that are utilized by and support the network-based trading platform and payment applications, according to an exemplary embodiment of the present invention;

FIG. 4 is a system that includes a search system, according to one exemplary embodiment of the present invention;

FIG. 5 is a block diagram illustrating a search engine and a rules engine, according to an exemplary embodiment of the present invention;

FIG. 6 is a block diagram illustrating a rules table and an items or listings table, according to an exemplary embodiment of the present invention;

FIG. 7 is a block diagram illustrating a search index that is used by the search engine, according to an exemplary embodiment of the present invention, to identify data items for a search result;

FIG. 8 is a flow chart illustrating a method, according to an exemplary embodiment of the present invention, to build a search database;

FIG. 9 is a flow chart illustrating a method, according to an exemplary embodiment of the present invention, for analyzing and tagging a listing;

FIG. 10 is a flow chart illustrating a method, according to an exemplary embodiment of the present invention, for using a search database;

FIGS. 11-12 illustrate user interface screens, according to an exemplary embodiment of the present invention; and

FIG. 13 illustrates a diagrammatic representation of a machine in the exemplary form of a computer system within which a set of instructions, for causing the machine to perform any one or more of the methodologies discussed herein, may be executed.

### DETAILED DESCRIPTION

A method and system to build and use a search database are described. In the following description, for purposes of explanation, numerous specific details are set forth in order to provide a thorough understanding of the present invention. It will be evident, however, to one skilled in the art that the present invention may be practiced without these specific details.

In general, embodiments described below feature a search system that facilitates building and using a search database. A data item (e.g., a listing) to be stored with a search database is received. A rules engine analyzes the data item based on a characteristic rule that may be associated with a demographic (e.g., country) or other filter criteria (e.g., fraudulent data). If the rules engine determines the data item should be prefiltered based on the filter criteria then the data item is characterized according to the filtered characteristic by identifying the data item with corresponding metadata (e.g., mark, flag, tag, etc.) before it is added to the search database. Henceforth, at search time, a data item may be filtered from a search result based on the metadata in the data item and without applying the corresponding characteristic rule.

The term “characteristic rule” is defined as a statement that describes one or more attribute values in a data item that may be used to distinguish one data item from another data item.

We below describe an embodiment of the invention in the context of a network-based commerce system to provide an illustrative application. However, it will be appreciated that the invention may be embodied in any search application or database environment.

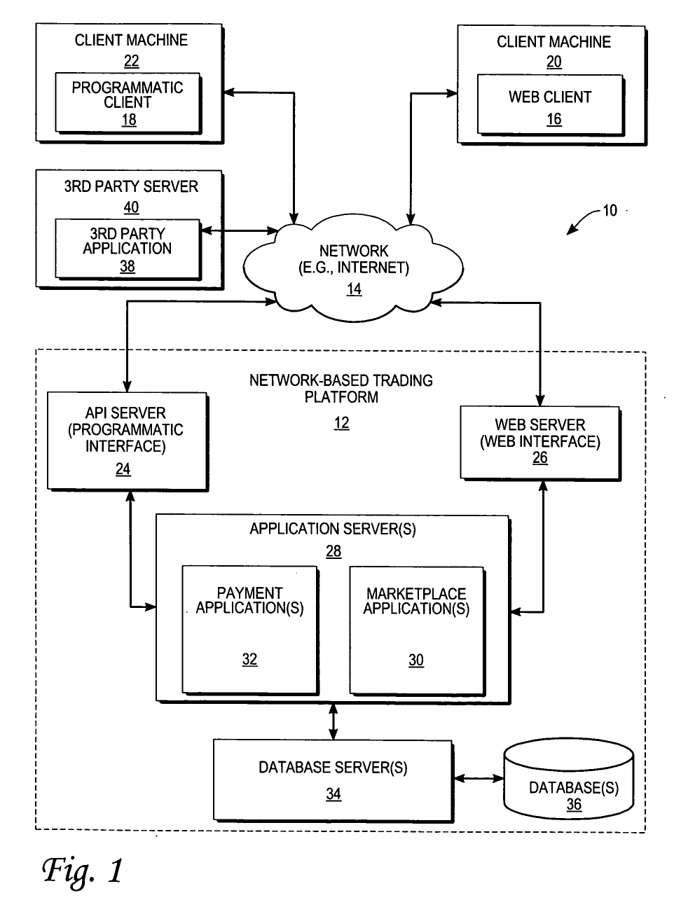

FIG. 1 is a network diagram depicting a system 10, according to one exemplary embodiment, having a client-server architecture. A commerce platform, in the exemplary form of a network-based trading platform 12, provides server-side functionality, via a network 14 (e.g., the Internet) to one or more clients. FIG. 1 illustrates, for example, a web client 16 (e.g., a browser, such as the Internet Explorer browser developed by Microsoft Corporation of Redmond, Wash. State), and a programmatic client 18 executing on respective client machines 20 and 22.

Turning specifically to the network-based trading platform 12, an Application Program Interface (API) server 24 and a web server 26 are coupled to, and provide programmatic and web interfaces respectively to, one or more application servers 28. The application servers 28 host one or more marketplace applications 30 and payment applications 32. The application servers 28 are, in turn, shown to be coupled to one or more databases servers 34 that facilitate access to one or more databases 36.

The marketplace applications 30 provide a number of marketplace functions and services to users that access the network-based trading platform 12. The payment applications 32 likewise provide a number of payment services and functions to users. The payment applications 32 may allow users to quantify for, and accumulate, value (e.g., in a commercial currency, such as the U.S. dollar, or a proprietary currency, such as “points”) in accounts, and then later to redeem the accumulated value for products (e.g., goods or services) that are made available via the marketplace applications 30. While the marketplace applications 30 and payment applications 32 are shown in FIG. 1 to both form part of the network-based trading platform 12, it will be appreciated that, in alternative embodiments of the present invention, the payment applications 32 may form part of a payment service that is separate and distinct from the network-based trading platform 12.

Further, while the system 10 shown in FIG. 1 employs a client-server architecture, the present invention is of course not limited to such an architecture, and could equally well find application in a distributed, or peer-to-peer, architecture system. The various marketplace and payment applications 30 and 32 could also be implemented as standalone software programs, which do not necessarily have networking capabilities.

The web client 16, it will be appreciated, accesses the various marketplace and payment applications 30 and 32 via the web interface supported by the web server 26. Similarly, the programmatic client 18 accesses the various services and functions provided by the marketplace and payment applications 30 and 32 via the programmatic interface provided by the API server 24. The programmatic client 18 may, for example, be a seller application (e.g., the TURBOLISTER application developed by eBay Inc., of San Jose, Calif.) to enable sellers to author and manage listings on the network-based trading platform 12 in an off-line manner, and to perform batch-mode communications between the programmatic client 18 and the network-based trading platform 12.

FIG. 1 also illustrates a third party application 38, executing on a third party server machine 40, as having programmatic access to the network-based trading platform 12 via the programmatic interface provided by the API server 24. For example, the third party application 38 may, utilizing information retrieved from the network-based trading platform 12, support one or more features or functions on a website hosted by the third party. The third party website may, for example, provide one or more promotional, marketplace or payment functions that are supported by the relevant applications of the network-based trading platform 12.

Marketplace and Payment Applications

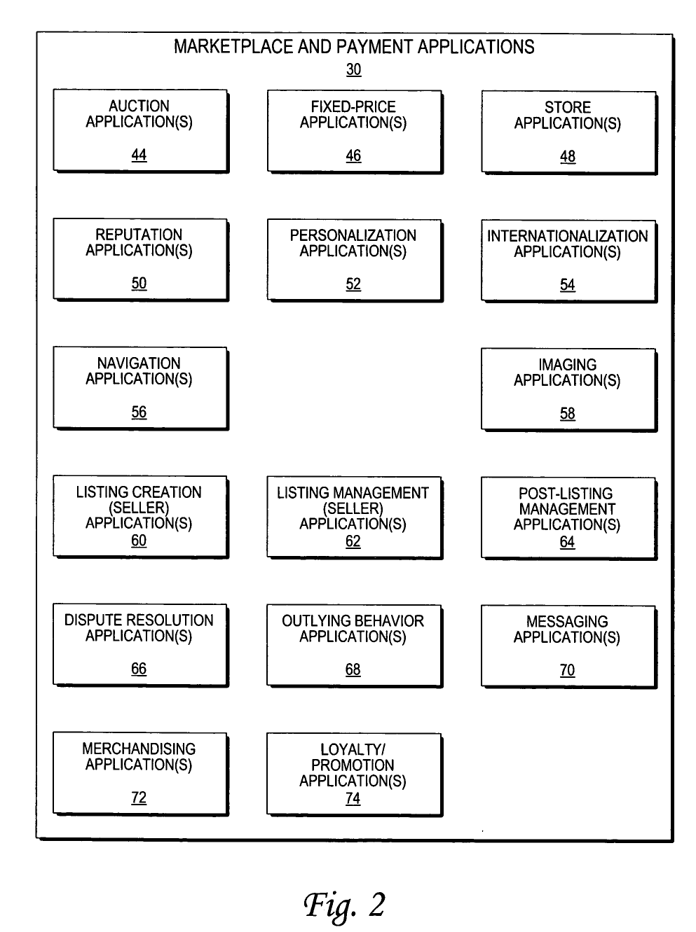

FIG. 2 is a block diagram illustrating multiple marketplace applications 30 and payment applications 30 that, in one exemplary embodiment of the present invention, are provided as part of the network-based trading platform 12. The network-based trading platform 12 may provide a number of listing and price-setting mechanisms whereby a seller may list goods or services for sale, a buyer can express interest in or indicate a desire to purchase such goods or services, and a price can be set for a transaction pertaining to the goods or services. To this end, the marketplace applications 30 are shown to include one or more auction applications 44 which support auction-format listing and price setting mechanisms (e.g., English, Dutch, Vickrey, Chinese, Double, Reverse auctions etc.). The various auction applications 44 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 46 support fixed-price listing formats (e.g., the traditional classified advertisement-type listing or a catalogue listing such as products or items posted on the websites of Amazon.com of Seattle, Wash.) and buyout-type listings. Specifically, buyout-type listings (e.g., including the Buy-It-Now (BIN) technology developed by eBay Inc., of San Jose, Calif. or the “Buy Price” feature developed by Yahoo! Inc., of Sunnyvale, Calif.) may be offered in conjunction with an auction-format listing, and allow a buyer to purchase goods or services, which are also being offered for sale via an auction, for a fixed-price that is typically higher than the starting price of the auction.

Store applications 48 allow sellers to group their listings within a “virtual” store, which may be branded and otherwise personalized by and for the sellers. Such a virtual store may also offer promotions, incentives and features that are specific and personalized to a relevant seller.

Reputation applications 50 allow parties that transact utilizing the network-based trading platform 12 to establish, build and maintain reputations, which may be made available and published to potential trading partners. Consider that where, for example, the network-based trading platform 12 supports person-to-person trading, users may have no history or other reference information whereby the trustworthiness and credibility of potential trading partners may be assessed. The reputation applications 50 allow a user, for example through feedback provided by other transaction partners, to establish a reputation within the network-based trading platform 12 over time. Other potential trading partners may then reference such a reputation for the purposes of assessing credibility and trustworthiness.

Personalization applications 52 allow users of the network-based trading platform 12 to personalize various aspects of their interactions with the network-based trading platform 12. For example a user may, utilizing an appropriate personalization application 52, create a personalized reference page at which information regarding transactions to which the user is (or has been) a party may be viewed. Further, a personalization application 52 may enable a user to personalize listings and other aspects of their interactions with the network-based trading platform 12 and other parties.

In one embodiment, the network-based trading platform 12 may support a number of marketplaces that are customized, for example, for specific geographic regions. A version of the network-based trading platform 12 may be customized for the United Kingdom, whereas another version of the network-based trading platform 12 may be customized for the United States. Each of these versions may operate as an independent marketplace, or may be customized (or internationalized) presentations of a common underlying marketplace. The latter version may characterize a user's access to the network-based trading platform 12 as originating from a particular country by identifying the country specific presentation that is selected by the user.

Navigation of the network-based trading platform 12 may be facilitated by one or more navigation applications 56. For example, a search application enables key word searches of listings published via the network-based trading platform 12. A browse application allows users to browse various category, catalogue, or inventory data structures according to which listings may be classified within the network-based trading platform 12. Various other navigation applications may be provided to supplement the search and browsing applications including a rules engine that applies a characteristic rule to a data item or listing to facilitate prefiltering of the listing, a scrubber for normalizing listings, and a search database engine for maintaining a search index and a search engine that facilitates the search and browse applications. Navigation applications are described further below with respect to the invention.

In order to make listings, available via the network-based trading platform 12, as visually informing and attractive as possible, the marketplace applications 30 may include one or more imaging applications 58 utilizing which users may upload images for inclusion within listings. An imaging application 58 also operates to incorporate images within viewed listings. The imaging applications 58 may also support one or more promotional features, such as image galleries that are presented to potential buyers. For example, sellers may pay an additional fee to have an image included within a gallery of images for promoted items.

Listing creation applications 60 allow sellers to conveniently author listings pertaining to goods or services that they wish to transact via the network-based trading platform 12, and listing management applications 62 allow sellers to manage such listings. Specifically, where a particular seller has authored and/or published a large number of listings, the management of such listings may present a challenge. The listing management applications 62 provide a number of features (e.g., auto-relisting, inventory level monitors, etc.) to assist the seller in managing such listings. One or more post-listing management applications 64 also assist sellers with a number of activities that typically occur post-listing. For example, upon completion of an auction facilitated by one or more auction applications 44, a buyer may wish to leave feedback regarding a particular seller. To this end, a post-listing management application 64 may provide an interface to one or more reputation applications 50, so as to allow the buyer to conveniently to provide feedback regarding a seller to the reputation applications 50. Feeback may take the form of a review that is registered as a positive comment, a neutral comment or a negative comment. Further, points may be associated with each form of comment (e.g., +1 point for each positive comment, 0 for each neutral comment, and −1 for each negative comment) and summed to generate a rating for the seller.

Dispute resolution applications 66 provide mechanisms whereby disputes arising between transacting parties may be resolved. For example, the dispute resolution applications 66 may provide guided procedures whereby the parties are guided through a number of steps in an attempt to settle a dispute. In the event that the dispute cannot be settled via the guided procedures, the dispute may be escalated to a third party mediator or arbitrator.

Messaging applications 70 are responsible for the generation and delivery of messages to users of the network-based trading platform 12, such messages for example advising users regarding the status of listings at the network-based trading platform 12 (e.g., providing “outbid” notices to bidders during an auction process or to provide promotional and merchandising information to users).

Merchandising applications 72 support various merchandising functions that are made available to sellers to enable sellers to increase sales via the network-based trading platform 12. The merchandising applications 80 also operate the various merchandising features that may be invoked by sellers, and may monitor and track the success of merchandising strategies employed by sellers.

The network-based trading platform 12 itself, or one or more parties that transact via the network-based trading platform 12, may operate loyalty programs that are supported by one or more loyalty/promotions applications 74. For example, a buyer may earn loyalty or promotions points for each transaction established and/or concluded with a particular seller, and be offered a reward for which accumulated loyalty points can be redeemed.

Marketplace Data Structures

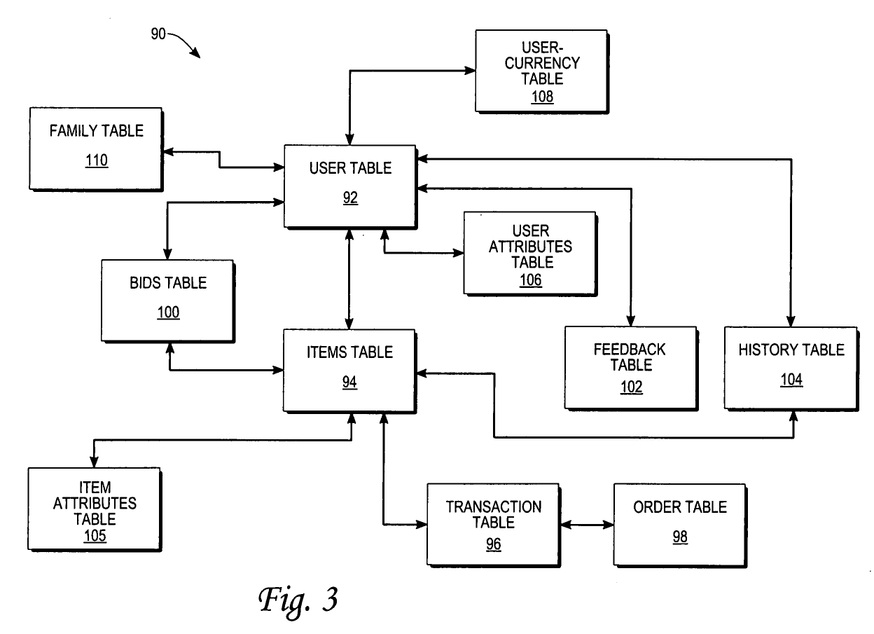

FIG. 3 is a high-level entity-relationship diagram, illustrating various tables 90 that may be maintained within the databases 36, and that are utilized by and support the marketplace applications 30 and payment applications 32. While the exemplary embodiment of the present invention is described as being at least partially implemented utilizing a relational database, other embodiments may utilize other database architectures (e.g., an object-oriented database schema).

A user table 92 contains a record for each registered user of the network-based trading platform 12, and may include identifier, address and financial instrument information pertaining to each such registered user. A user may operate as a seller, a buyer, or both, within the network-based trading platform 12. In one exemplary embodiment of the present invention, a buyer may be a user that has accumulated value (e.g., commercial or proprietary currency), and is then able to exchange the accumulated value for items that are offered for sale by the network-based trading platform 12.

The tables 90 also include an items or listings table 94 in which are maintained item records for goods and services that are available to be, or have been, transacted via the network-based trading platform 12. Each item record within the items table 94 may furthermore be linked to one or more user records within the user table 92, so as to associate a seller and one or more actual or potential buyers with each item record.

A transaction table 96 contains a record for each transaction (e.g., a purchase transaction) pertaining to items for which records exist within the items table 94.

An order table 98 is populated with order records, each order record being associated with an order. Each order, in turn, may be with respect to one or more transactions for which records exist within the transactions table 96.

Bid records within a bids table 100 each relate to a bid received at the network-based trading platform 12 in connection with an auction-format listing supported by an auction application 44. A feedback table 102 is utilized by one or more reputation applications 50, in one exemplary embodiment, to construct and maintain reputation information concerning users. A history table 104 maintains a history of transactions to which a user has been a party. One or more attributes tables including an item attributes table 105 that records attribute information pertaining to items for which records exist within the items table 94 and a user attributes table 106 that records attribute information pertaining to users for which records exist within the user table 92.

It will be appreciated that the invention may be used, for example, to search anyone of the above databases, but is described below as facilitating the search of a listing database by a search system.

Search Architecture and Applications

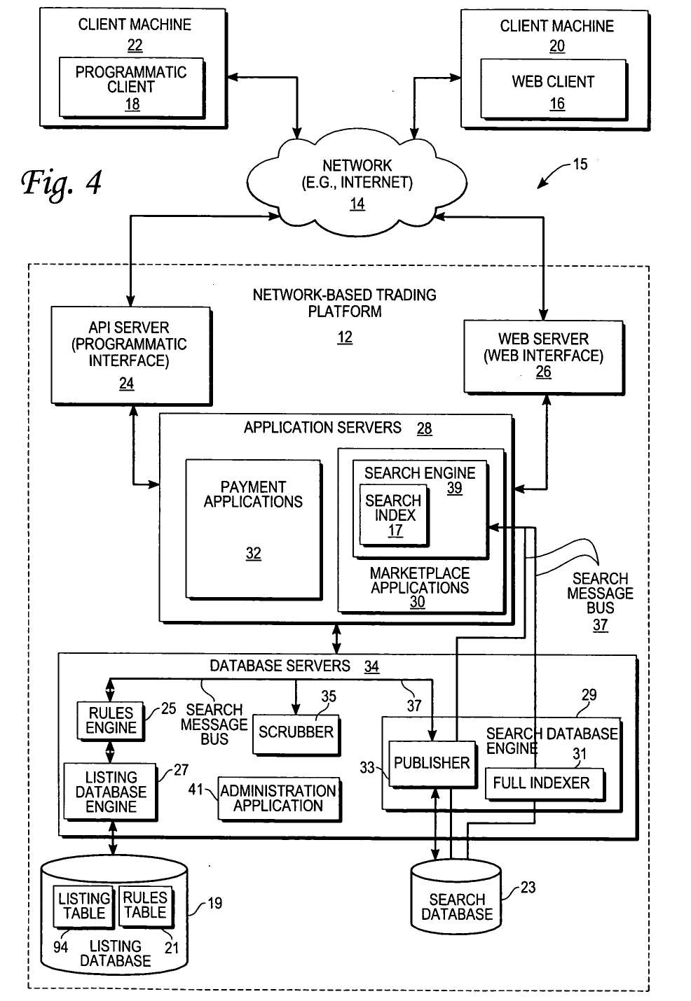

FIG. 4 is a block diagram illustrating a search system 15 that includes the navigation applications described above, as embodied in the network based trading platform 12, according to an exemplary embodiment. The search system 15 includes search system components located on or connected to the application servers 28 and the database servers 34.

The application servers 28 include a search engine 39 that includes a search index 17. The search engine 39 services search requests from users by returning search results that include one or more listings. The search index 17 is a reverse index that is utilized by the search engine 39 to identify one or more listings based on a search request entered by a user.

A search request may take the form of a keyword request or a browse request. A browse request is utilized by a user to browse various category, catalogue, or inventory data structures according to which listings may be classified within the network-based trading platform. A keyword request is utilized by a user to identify listings that contain text that match keyword(s) entered by a user.

The database servers 34 support a rules engine 25, an administration application 41, a listing database engine 27, a normalizer in the exemplary form of a scrubber 35 and a search database engine 29. In addition, the database servers provide connections to a search database 23 and a listing database 19 that includes an item or listing table 94 and a rules table 21.

The listing database engine 27 facilitates adding, updating, and deleting listings in the listing table 94. In addition, the listing database engine 27 may provide additional services including the storage and retrieval of currency exchange rates, category structures (e.g., listings are maintained in hierarchies of categories and other classification schemes), zip code to regional identification maps and other information. The listing database engine 27 utilizes the rules engine 25 to analyze a listing. More specifically, the rules engine 25 may retrieve a characteristic rule from a rules table 21 and apply the characteristic rule to the listing to determine whether the listing should be characterized (e.g., tagged, marked, flagged, etc. with metadata) to indicate that characterization. The characterization may be to facilitate a subsequent filtering of the listing from a search result or to perform additional processing before the listing is added to the listing table 94. A rule is associated with a particular filter criteria (e.g., inappropriate for a particular country).

The administration application 41 supports a user interface that is utilized by administrative personnel to add, delete, and modify rules that are stored in the rules table 21 and processed with the rules engine 25 as described above.

The scrubber 35 is used to normalize a listing. More specifically, the scrubber 35 may for example strips HTML tags from the description, converts text fields to Unicode, normalize all date fields to a common date format, normalize all measurement units to a common measurement unit, and normalizes all prices based on exchange rates to a common currency. For example, the scrubber 35 may convert the measurement unit of miles into kilometers. Another example may include converting Euros into US dollars. Similarly, the scrubber 35 may convert Greek letters, or the standard alphabet into a Unicode, such as UTF8. Normalization enables searching across a heterogeneous set of listings with a simplified search algorithm.

The search database engine 29 includes a publisher 33 and a full indexer 31. The publisher 33 adds, deletes and updates normalized listings both in the search database 23 and in the search index 17. The full indexer 31 generates and updates a complete search index 17 in the search engine 39 responsive to fragmentation of the search index 17 from the addition and deletion of listings or responsive to initializing of the search engine 39.

The components of the search system 15 may communicate with each other over a search message bus 37 that utilizes publish/subscribe middleware and database access software. In one embodiment the middleware may be embodied as TIBCO RENDEZVOUS™, a middleware or Enterprise Application Integration (EAI) product developed by Tibco Software, Inc. Palo Alto, Calif.

The search system 15 responds to search requests by maintaining a normalized memory resident copy of all listings in the network-based trading platform 12 in the search index 17. Thus, the search engine 39 may respond to a search request by accessing the memory resident search index 17 to obtain the requested listings without a performance penalty that comes from the processing overhead and delay associated with a database access. One example of a data flow to maintain listing information is described. In response to a user adding a listing, the rules engine 25 analyzes the listing based on one or more characteristic rules that may result in a characterization (and resultant tagging) of the listing before passing control to the listing database engine 27. The listing database engine 27 updates the listing database 19, thereby triggering a publishing of the newly added listing to the scrubber 35. The scrubber 35 normalizes the listing by retrieving other information from the listing database 19 including currency exchange rates, category structures, zip code to regional identification maps. The scrubber 35 stores the normalized listing in the search database 23 via the publisher 33, thereby causing the publisher 33 to publish the normalized listing to the search index 17 in the search engine 39. A similar data flow may result from an update or deletion of a listing. It will be appreciated that the above described dataflow may also be invoked for every listing in the listing table 94 responsive to a rule change (e.g., addition, deletion or modification), a currency exchange rate change, a category structure change, a zip code to regional mapping change, or any other modification which may require a reevaluation of the listing by the rules engine 25 or the scrubber 35.

The other pathway between the search database 23 and the search engine 39 is via the full indexer 31. As described above, this path is utilized for a batch update of the search engine. The full indexer 31 retrieves listings from the search database, builds a new search index 17, and publishes the entire search index 17 to the search engine 39.

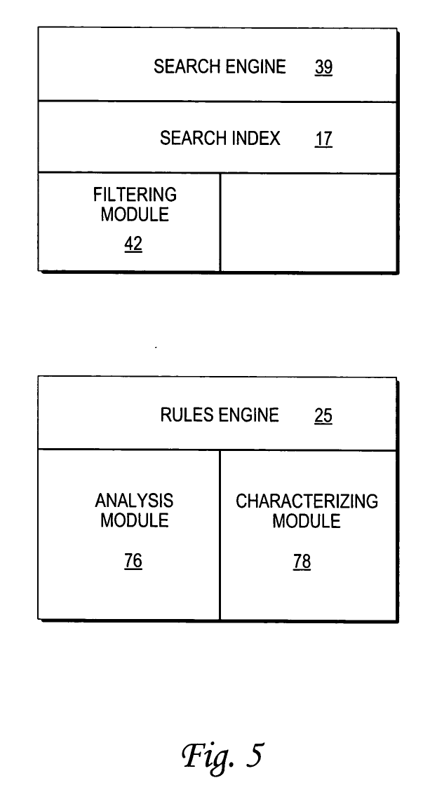

FIG. 5 is a block diagram illustrating a search engine 39 and a rules engine 25. The search engine 39 includes a search index 17 and a filtering module 42. The search index 17 includes an in-memory copy of every listing in the network-based trading platform 12. The filtering module 42 associates a search request with a country and removes all listings from the corresponding search result that are tagged with the same country.

The rules engine 25 includes an analysis module 76 and a characterizing module 78. The analysis module 76 analyzes a listing that has been added or updated utlizing a characteristic rule that may include, for example, a profanity rule, an obscenity rule, a fraud rule or a legal prohibition rule. It will be appreciated that other types of rules may be generated based on a variety of filtering requirements. The analysis module 76 may invoke the characterizing module 78 to tag the listing to invoke further processing before the listing is added to the listing database 19, or to flag the removal the listing from a search result.

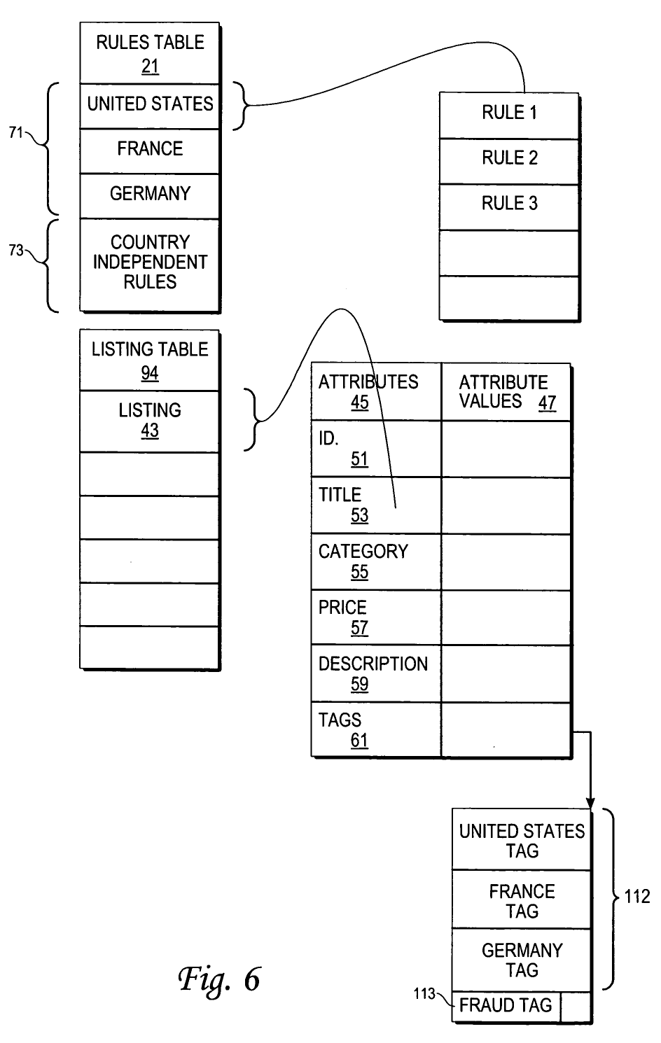

FIG. 6 is a block diagram illustrating an exemplary rules table 21 and an exemplary listing table 94. The rules table 21 includes country specific rule sets 71 and a country independent rule set 73. For example, each country (e.g., United States, France, Germany, etc.) may be associated with a corresponding set of country specific rules 71. The listing table 94 includes items or listings 43. Each listing 43 includes attributes 45 with corresponding attribute values 47. The attributes 45 may include a listing identification 51, a title 53, a category 55, a price 57, a description 59 and tags 61, for example. The tags 61 may include one or more country tags 112 and/or a fraud tag 113.

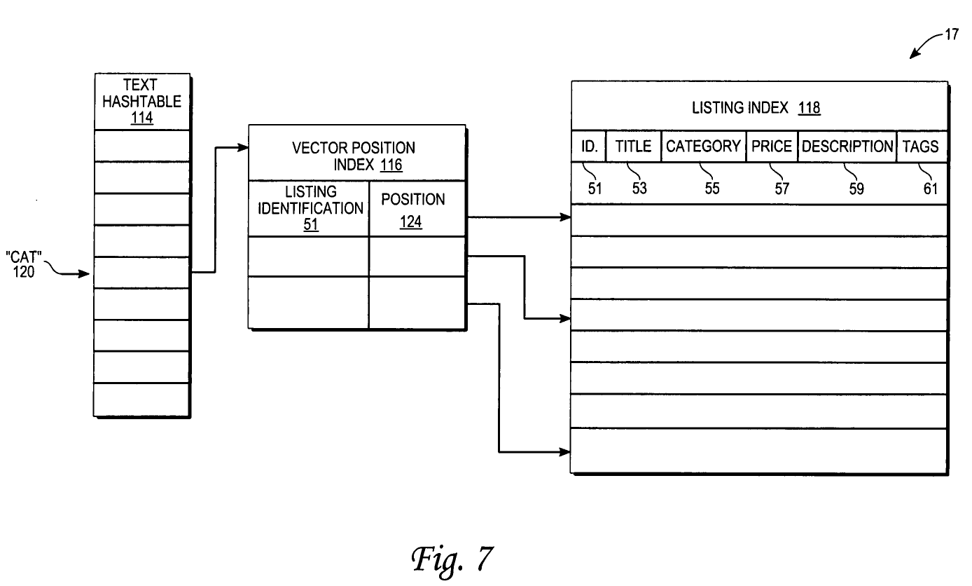

FIG. 7 is a block diagram illustrating a search index 17, according to an exemplary embodiment of the present invention. The search index 17 includes a text hash table 114. Each entry in the hash table 114 corresponds to one or more vector position indexes 116. Each vector position index 116 corresponds to a listing in a listing index 118.

The text hash table 114 is utilized to identify a set of vector position indexes based on a keyword. For example, the keyword “cat” 120 may hash to a set of three-vector position indexes 116. Each vector position index 116 identifies a single listing 43 with a listing identification 51 and the word position of the word “cat” 120 in the listing 43.

The listing index 118 includes all listings 43 on the network based trading platform 12 and a full set of attributes 41 and attribute values 47 for each normalized listing 43. In other words, the listing index 118 is a normalized and full representation of the listings as stored in a listing table 94. It will be appreciated that a memory resident full representation of a listing 43 results in minimizing the response time to deliver a search result and in enhancing the accuracy of the search result.

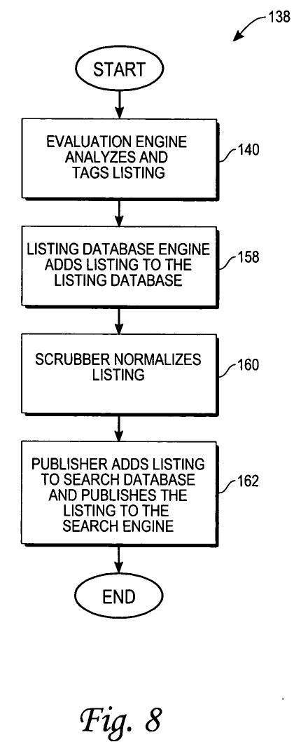

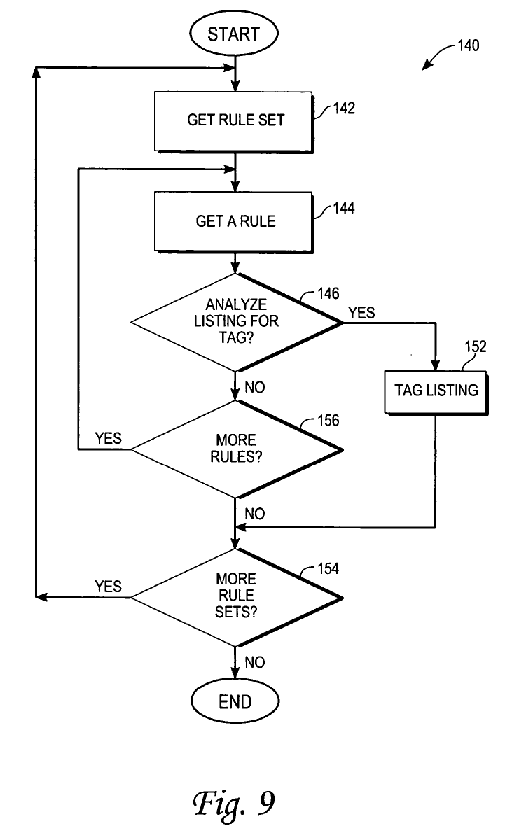

FIG. 8 is a flow chart illustrating a method 138, according to an exemplary embodiment, to build a search database. At box 140, the rules engine 25 analyzes and tags a listing 43 that has been previously entered by a user from a client machine 20, as illustrated in FIG. 9, according to an exemplary embodiment of the present invention.

In FIG. 9, at box 142, the rules engine 25 gets a rule set. The rule set may be a country specific rule set 71 or a country independent rule set 73.

At box 144, the rules engine 25 gets the next rule from the rule set from the rules table 21. For example, the rules engine 25 may get a profanity rule from the country specific rule set 71 for Germany.

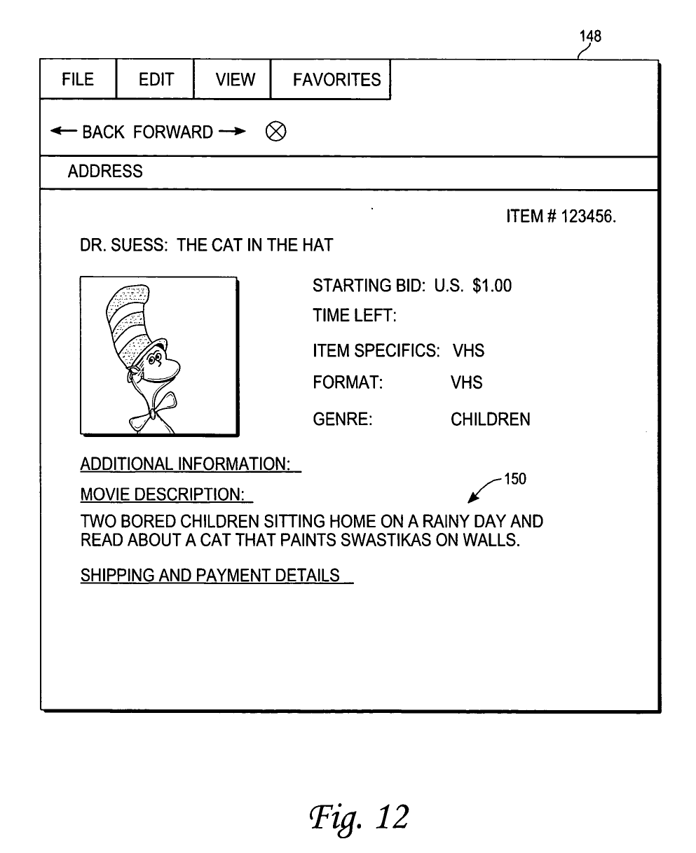

At box 146, the analysis module 76 analyzes the listing by applying the profanity rule to the attribute values 47 of the listing 43 (e.g., the text attribute values 47 including the title 53, the description 59 and any other text attribute value in the listing). For example, a seller at the client machine 20 may be listing the Dr. Seuss book, “The Cat in the Hat” for sale on the network based trading platform 12. FIG. 12 illustrates a user interface 148 that includes the previously described listing, according to an exemplary embodiment of the present invention. The user interface 148 includes a description 150 that reads, “Two bored children sitting home on a rainy day and read about a cat that paints swastikas on walls.”

Returning to FIG. 9, at decision box 146, the analysis module 76 uses the profanity rule associated with Germany to analyze the listing. For each attribute value 47 that contains text, the analysis module 76 parses the text into words and compares each word with the word “swastika”. In the present example, the analysis module 76 branches to box 152 after it identifies that the listing contains the word “swastika” in the description attribute value of the listing. Otherwise a branch is made to decision box 156.

It will be appreciated that other rules may identify other words that are inappropriate to citizens of other countries. For example, in some contexts the use the title “World Trade Center” may be considered offensive to citizens of the United States (e.g., a deck of playing cards with pictures) and in some contexts the use of the name “Falkland Islands” in place of the name “Las Islas Malvinas” may be offensive to citizens of Argentina because it impliedly recognizes the legitimacy of English rule.

Some embodiments may utilize an obscenity rule to filter listings 43 from the search results of a country. The obscenity rule operates in the same manner as the profanity rule; however, the analysis module 76 utilizes the obscenity rule to analyze pictures rather than text.

In some embodiments, a legal prohibition rule may be utilized to characterize a listing 43 that suggests or requires an action that is legally prohibited by the associated country. For example, a legal prohibition rule may be utilized to tag a listing 43 that includes text that promotes the sale or transport of alcoholic beverages across a state or country boundary (e.g., presuming such a sale or transport is illegal). A similar rule may result in a characterization of a listing 43 that includes text regarding the sale or auction of a pharmaceutical product for a country that prohibits such a sale without first acquiring a prescription from a doctor.

Further, a listing 43 may be characterized for positive filtering. In other words a tag may trigger additional preprocessing rather than subsequent filtering. For example, a rule may result in tagging a listing 43 that may include text or numeric data that suggests fraudulent activity (e.g., unusual price or quantity for a product or service). Tagging a listing with a fraud tag 113 may result in setting a timeout period and adding the listing to a queue. Administrative personnel may subsequently review the listing and other listings that are waiting on the queue to determine if the suspicion is warranted. The administrative personal will not add a listing that is suspected of fraud to the listing table 94 and take additional actions to preserve the integrity of the network-based trading platform 12 and buyers. Conversely, a timeout recognizes that administrative personnel may not be available and results in the automatic addition of the listing to the listing table 94.

Further, other embodiments may include a rule that is not associated with a specific country. For example, the above described fraudulent activity rule may be implemented as a country specific rule or a country independent rule. Also, some presentations of profanity or obscenity may rise to the level of international opprobrium and thus be detected with a rule that is not associated with a specific country. In these examples, the listing is not added to the listing table 94 because they would be filtered from a search result notwithstanding the country associated with the search result.

On FIG. 9, at box 152, the characterizing module 78 in the rules engine 25 stores a tag associated with Germany in the tags 61 field of the listing 43. Thus, the listing is identified as inappropriate for inclusion in search results that are associated with the country Germany because it may contain language that may be offensive to a German. Note that the listing is tagged prior to storing the listing in the listing database 19, search database 23, or search index 17. Thus, the above described processing is performed once notwithstanding multiple instances of filtering the above-described listing from search results associated with multiple search requests that are associated the country Germany. Thus, the rules engine 25 optimizes searching by characterizing and tagging the listing as inappropriate for search results associated with Germany prior to processing one or more search requests associated with Germany.

At decision box 156, the analysis module 76 determines if there are more rules in the rule set. If the there are more rules in the rule set then the analysis module 76 branches to box 144. Otherwise processing continues at decision box 154.

At decision box 154, if the analysis module 76 determines if there are more rule sets. If additional rule sets exist then the analysis module 76 branches to box 142. Otherwise processing continues at box 158.

Returning to FIG. 8, at box 158, the listing database engine adds the listing 43 to the listing database 19 and publishes the listing 43 to the scrubber 35.

At box 160 the scrubber 35 normalizes the listing 43, as previously described, and publishes the listing 43 to the publisher 33.

At box 162 the publisher 33 adds the listing to the search database 23 and publishes the listing to the search index 17 in the search engine 39 on the application server 28.

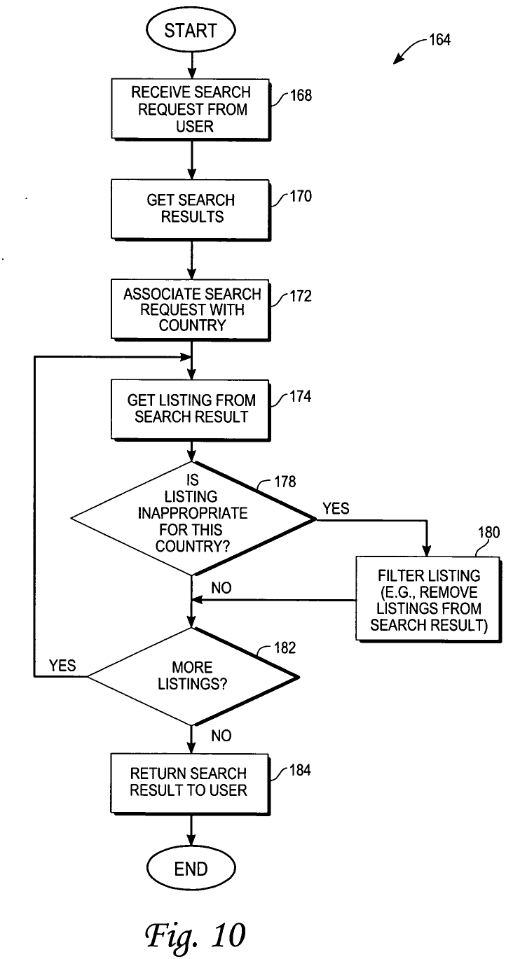

FIG. 10 is a flowchart illustrating a method 164, according to an exemplary embodiment of the present invention, to use a search database. At box 168, the filtering module 42 receives a search request entered by a user at client machine 20, the search request including the words, “Cat in the Hat”.

At box 170, the filtering module 42 parses each word in the search request, filters out the words “in” and “the”, and hashes the words “cat” and “hat” to identify the corresponding entries in the hash table 114 and extract a superset of vector position indexes 116 from the search index 17. The superset of vector position indexes 116 identifies the search result, which contains all listings in the network-based trading platform 12 that contain the words “cat” and/or “hat”.

At box 172, the filtering module 42 associates the search request with a country. The filtering module 42 may determine the country in a number of different ways. In one embodiment, the filtering module 42 may determine the country based on the web page that received the search request. For example, the filtering module will associate a search request with Germany if the user entered the search request (e.g., “Cat in the Hat”) from a web page with a German presentation of the network-based trading platform 12. In other embodiments, the web page may be associated with a web site that is associated with the country Germany.

The filtering module 42 may also determine the country based on a user profile that corresponds to the identity of the user that entered the search request. For example, each user in the system must register demographic information before using the network based trading platform 12 including a residence address that will include the name of a country. The filtering module 42 determines the residence address of the user by associating the search request with the corresponding user profile via the user table 92.

The filtering module 42 may also determine the country of the user requesting search results based on the geostationary position of the user at the time of the search request. For example, a user standing in the train station in Heidelberg, Germany may enter a search request using a mobile phone with text capabilities. Responsive to receiving the search request and the location, Heidelburg, Germany, the filtering module 42 would associate the search request with the country Germany. It will be appreciated that the country Germany is only one demographic characteristic of a user that may be used. Other embodiments may include demographic characteristics such as region, state, zip-code, sex, etc.

At box 174 the analysis module 76 gets a listing from the search result which may include more than one listing.

At decision box 178 the filtering module 42 determines if the listing 43 is inappropriate by comparing the country associated with the search request with the corresponding country tag 112 in the listing 43. In the present example, if the search request is associated with Germany then the listing 43 that includes the word “swastika”, would be removed from the search result because the German tag is asserted. If the listing 43 is inappropriate for the country associated with the search result then a branch is made to box 180. Otherwise a branch is made to decision box 182.

At box 180, the filtering module 42 removes the listing 43 from the search result.

At decision box 182, the filtering module 42 determines if there are more listings 42 in the search result. If more listings are in the search result then a branch is made to box 174. Otherwise, a branch is made to box 184.

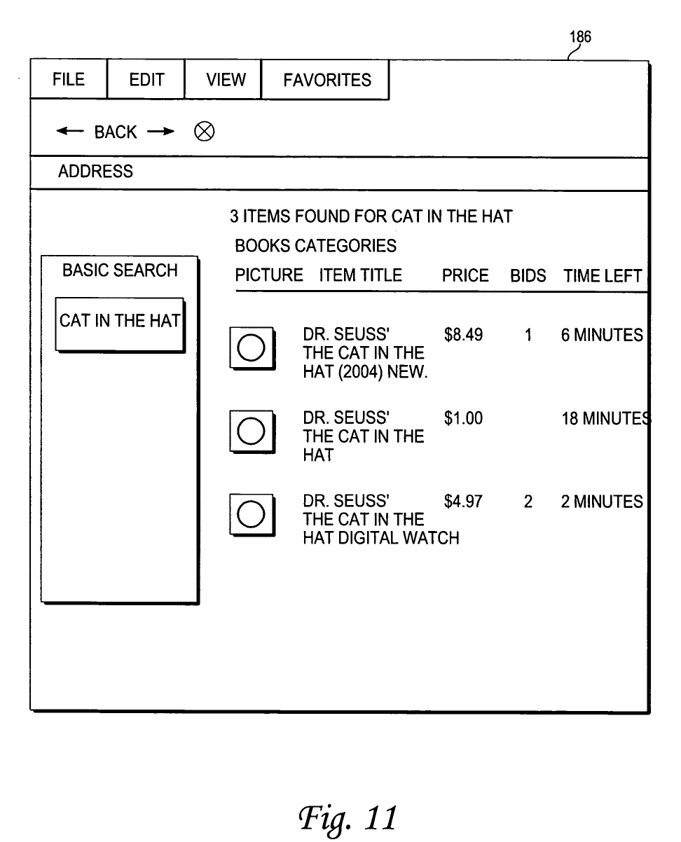

At box 184, the filtering module 42 returns the search result to the user which is displayed on the user's screen as illustrated by the user interface screen 186, according to an exemplary embodiment of the present invention, on FIG. 11. The user interface 186 illustrates a search result that includes three entries, each entry including the string “Cat in the Hat”; however, the listing with the word swastikas is not present because it was removed by the filtering module 174.

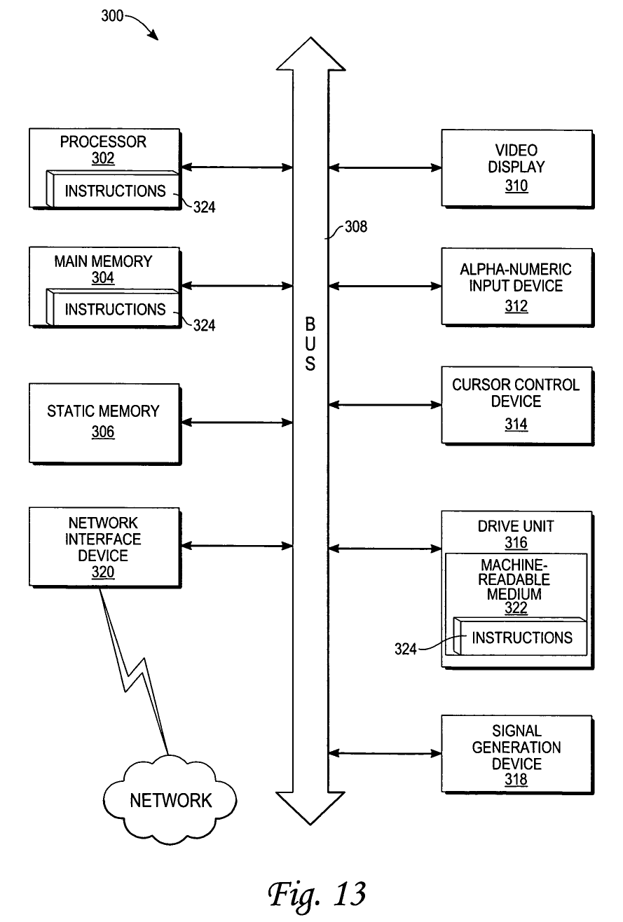

FIG. 13 shows a diagrammatic representation of machine in the exemplary form of a computer system 300 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 300 includes a processor 302 (e.g., a central processing unit (CPU) a graphics processing unit (GPU) or both), a main memory 304 and a static memory 306, which communicate with each other via a bus 308. The computer system 300 may further include a video display unit 310 (e.g., a liquid crystal display (LCD) or a cathode ray tube (CRT)). The computer system 300 also includes an alphanumeric input device 312 (e.g., a keyboard), a cursor control device 314 (e.g., a mouse), a disk drive unit 316, a signal generation device 318 (e.g., a speaker) and a network interface device 320.

The disk drive unit 316 includes a machine-readable medium 322 on which is stored one or more sets of instructions (e.g., software 324) embodying any one or more of the methodologies or functions described herein. The software 324 may also reside, completely or at least partially, within the main memory 304 and/or within the processor 302 during execution thereof by the computer system 300, the main memory 304 and the processor 302 also constituting machine-readable media.

The software 324 may further be transmitted or received over a network 326 via the network interface device 320.

While the machine-readable medium 392 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and system for building and using a search database was described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A method to build a search database, the method including:
analyzing a data item to be stored in the search database using a characteristic rule; and
characterizing the data item based on the analyzing thereof;
wherein the characterizing is utilized to filter a subsequent search result generated responsive to a search request received against the search database.

2. The method of claim 1, wherein the data item is a listing and the search database is to support network-based commerce.

3. The method of claim 1, wherein the characterizing includes tagging the data item to indicate a characterization.

4. A method including:
analyzing a data item associated with a search database utilizing a characteristic rule;
characterizing the data item based on the analyzing thereof;
receiving a search request against the search database; and
filtering a search result based on the characterizing of data items associated with the search database.

5. The method of claim 4, wherein the filtering includes tagging the data item to indicate the characterization.

6. The method of claim 5, wherein the tagging of the data item includes tagging the listing as potentially being fraudulent.

7. The method of claim 4, wherein the filtering includes removing the data item from the search result based on the characterization thereof.

8. The method of claim 4, wherein the characterizing of the data item includes identifying the data item as an inappropriate presentation to a user of a particular demographic.

9. The method of claim 8, wherein the particular demographic comprises any one of a group including an age demographic, a region demographic, a country demographic, a state demographic, a sex demographic, and a zip code demographic.

10. The method of claim 8, wherein the identifying of the data item as inappropriate for the particular demographic includes utilizing a presentation rule that is associated with a country.

11. The method of claim 8, further including associating the search result with a demographic based on a physical location of a user.

12. The method of claim 11, wherein the physical location of the user is determined when a search request is entered by the user.

13. The method of claim 8, further including associating the search result with the particular demographic based on a user profile.

14. The method of claim 8, further including associating the search result with the particular demographic based on a web site that receives a search request.

15. The method of claim 8, wherein the data item is inappropriate for the particular demographic based on a legal prohibition.

16. The method of claim 8, wherein the data item is inappropriate for the particular demographic based on offensive language.

17. The method of claim 4, further including normalizing an attribute value in the data item.

18. The method of claim 17, wherein the normalizing of the attribute value of the data item comprises any one of a group including normalizing to a standard measurement unit, normalizing to a single currency, and normalizing to a common character set.

19. The method of claim 4, wherein the characterizing is performed before receiving a search request.

20. A system, the system including:
an analysis module to analyze a data item associated with a search database utilizing a characteristic rule; and
a characterizing module to characterize the data item based on the analysis thereof;
wherein the characterizing is utilized to filter a subsequent search result based responsive to a search request received against the datbase.

21. The system of claim 20, wherein the data item is a listing and the search database is to support network-based commerce.

22. The system of claim 20, wherein to characterize includes to tag the data item to indicate a characterization.

23. A system including:
an analysis module to analyze a data item associated with a search database utilizing a characteristic rule;
a characterizing module to characterize the data item based on the analysis thereof; and
a filtering module to receive a search request against the search database and to filter a search result based on the characterization of data items associated with the search database.

24. The system of claim 23, wherein the filtering module to filter includes to tag the data item to indicate the characterization.

25. The system of claim 24, wherein the filtering module to tag the data item includes to tag a listing as potentially being fraudulent.

26. The system of claim 23, wherein the filtering module to filter includes to remove the data item from the search result based on the characterization thereof.

27. The system of claim 23, wherein the characterizing module to characterize the data item includes to identify the data item as an inappropriate presentation to a user of a particular demographic.

28. The system of claim 27, wherein the particular demographic comprises any one of a group including an age demographic, a region demographic, a country demographic, a state demographic, a sex demographic, and a zip code demographic.

29. The system of claim 27, wherein the characterizing module to identify the data item as inappropriate for the particular demographic includes to utilize a presentation rule that is associated with a country.

30. The system of claim 27, further including the filtering module to associate the search result with a demographic based on a physical location of a user.

31. The system of claim 30, wherein the physical location of the user is determined when a search request is entered by the user.

32. The system of claim 27, further including the filtering module to associate the search result with the particular demographic based on a user profile.

33. The system of claim 27, further including the filtering module to associated the search result with the particular demographic based on a web site that receives a search request.

34. The system of claim 27, wherein the data item is inappropriate for the particular demographic based on a legal prohibition.

35. The system of claim 27, wherein the data item is inappropriate for the particular demographic based on offensive language.

36. The system of claim 23, further including a normalizer to normalize an attribute value in the data item.

37. The system of claim 36, wherein the normalizer to normalize the attribute value of the data item comprises any one of a group including to normalize to a standard measurement unit, to normalize to a single currency, and to normalize to a common character set.

38. The system of claim 23, wherein the characterizing module to characterize is performed before the filtering module is to receive a search request.

39. A machine readable medium storing a set of instructions that, when executed by the machine, cause the machine to:
analyze a data item to be stored in the search database using a characteristic rule; and
characterize the data item based on the analysis thereof;
wherein the characterization is utilized to filter a subsequent search result generated responsive to a search request received against the search database.

40. A machine readable medium storing a set of instructions that, when executed by the machine, cause the machine to:
analyze a data item to be stored in the search database using a characteristic rule; and
characterize the data item based on the analysis thereof;
wherein the characterization is utilized to filter a subsequent search result generated responsive to a search request received against the search database.

41. A system to use a search database, the system including:
a first means to analyze a data item associated with a search database utilizing a characteristic rule;
a second means to characterize the data item based on the analysis thereof; and
a third means to receive a search request against the search database and to filter a search result based on the characterization of data items associated with the search database.

42. A system to build a search database, the system including:
a first means to analyze a data item to be stored in the search database using a characteristic rule; and
a second means to characterize the data item based on the analysis thereof;
wherein to characterize is utilized to filter a subsequent search result generated responsive to a search request received against the search database.
